(19) United States
(12) Patent Application Publication
(10) Pub. No.: US 2010/0318745 A1
(43) Pub. Date: Dec. 16, 2010

(54) Dynamic Content Caching and Retrieval

(75) Inventors: Graham A. Wheeler, Redmond, WA (US); David Abzarian, Kirkland, WA (US); Todd L. Carpenter, Monroe, WA (US); Didier Coussemaeker, Seattle, WA (US); Nicolas Mai, Seattle, WA (US); Jian Lin, Sammamish, WA (US); Severan Rault, Kirkland, WA (US); Danny Lange, Sammamish, WA (US); Femando P. Zandona, Sammamish, WA (US); Joseph Futty, Sammamish, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/485,659

(22) Filed: Jun. 16, 2009

(51) Int. Cl. G06F 12/08; G06F 12/00

(52) U.S. Cl. 711/136; 711/133; 719/328; 711/E12.001

(57) ABSTRACT

This disclosure provides techniques for dynamic content caching and retrieval. For example, a computing device includes cache memory dedicated to temporarily caching data of one or more applications of the computing device. The computing device also includes storage memory to store data in response to requests by the applications. The storage memory may also temporarily cache data. Further, the computing device includes system software to represent to the applications of the computing device that the portions of the storage memory utilized to cache content are available to store data of the applications. In addition, the computing device includes application programming interfaces to provide content to a requesting application from a cache of the computing device and/or from a remote content source.

### BACKGROUND

Many computing device users expect to quickly retrieve requested information. Some users of communication networks may experience slow data transfers and dropped connections resulting in delays to retrieve information from a particular source. Thus, a user's experience with a computing device can be degraded in situations where a computing device is frequently accessing content sources via a network and regularly experiences delays in retrieving information.

In some instances, computing devices cache content locally to improve a user's experience when retrieving content from a source via a communications network. Caching involves temporarily storing copies or portions of previously requested data in a local memory because content can typically be retrieved more quickly from local memory than from a slower resource, such as a network server. In this way, delays in retrieving content can be decreased.

However, computing devices typically communicate with the content source in order to determine if cached content is fresh before permitting access to the content. For example, some versions of hypertext transfer protocol (HTTP) utilize entity tags assigned to particular content and computing devices send the entity tags to a content server to determine whether the particular content is fresh. In response to receiving a respective entity tag corresponding to particular content, the content source may respond by extending the lifetime of the particular content or by providing fresh content. Thus, a user may still experience a delay before accessing the requested content as the computing device communicates with the content source to verify that fresh content is provided in response to the request.

Further, in some instances, the memory space available at a computing device, such as a mobile handset or smart phone, may be limited. Dedicating too much memory space to temporarily cache content locally may negatively affect some applications and/or users of the computing device due to a lack of available storage memory space for the applications and/or users to store data. In addition, the number of applications stored at the computing device may also be limited when the amount of storage space is reduced in favor of memory space to cache content.

### SUMMARY

This disclosure describes techniques to dynamically cache and retrieve content. For example, a method to dynamically cache content includes receiving an indication that an application is requesting to store data in storage memory of a computing device. The memory of the computing device also includes cache memory designated to temporarily cache data of one or more applications and/or services of a computing device. A file system filter of the computing device may be configured to temporarily cache content in storage memory of the computing device. For example, the file system filter may cache content in hard disk space or persistent flash memory of the computing device. Upon receiving the indication that the application is requesting to store data in storage memory of the computing device, the file system filter determines whether the storage memory of the computing device memory includes sufficient space to store the specified data. When the storage memory of the computing device includes insufficient space to store the specified data, the file system filter removes content cached in the storage memory to provide enough memory space to store the specified content.

In another aspect, an application of the computing device may request to retrieve content from a remote content source. In some instances, the request may be produced based on input received from a user of the computing device. The computing device may include application programming interfaces (APIs) to provide the content to the requesting application. For example, a first API may return stale content cached at the computing device in response to the request to minimize any delays between the time the request is made and a response is provided to the requesting application. Additionally, a second API may return fresh content to the requesting application. The fresh content may be cached at the computing device or retrieved from the remote content source.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE CONTENTS

The detailed description is described with reference to accompanying FIGs. In the FIGs, the left-most digit(s) of a reference number identifies the FIG. in which the reference number first appears. The use of the same reference numbers in different FIG.s indicates similar or identical items.

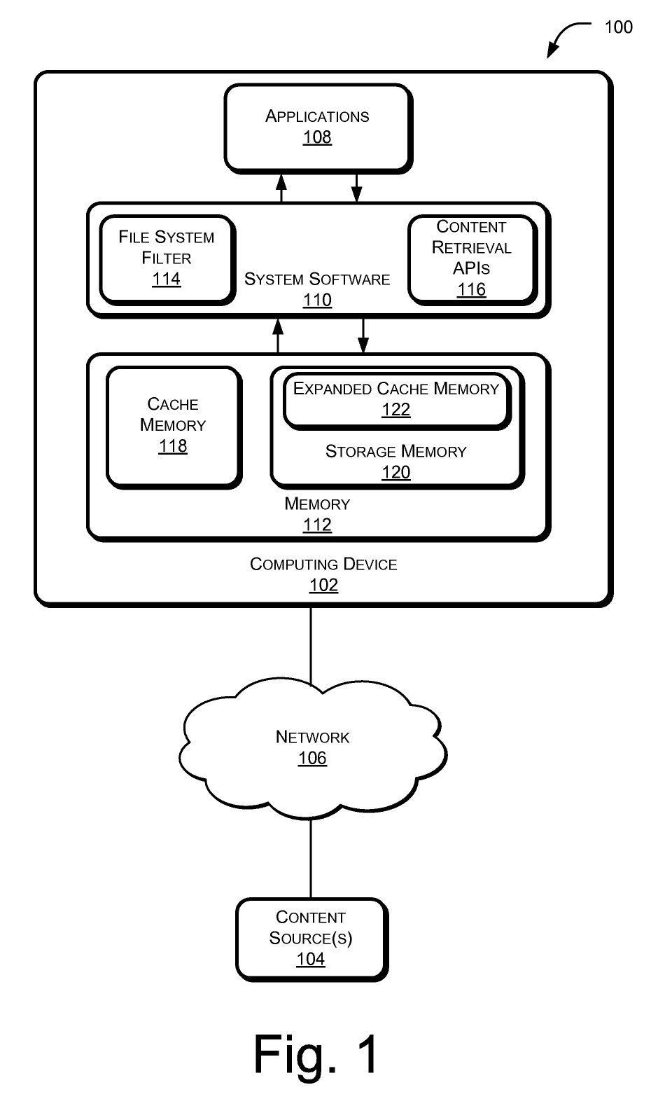

FIG. 1 is a diagram illustrating an embodiment of a system to dynamically cache and retrieve content.

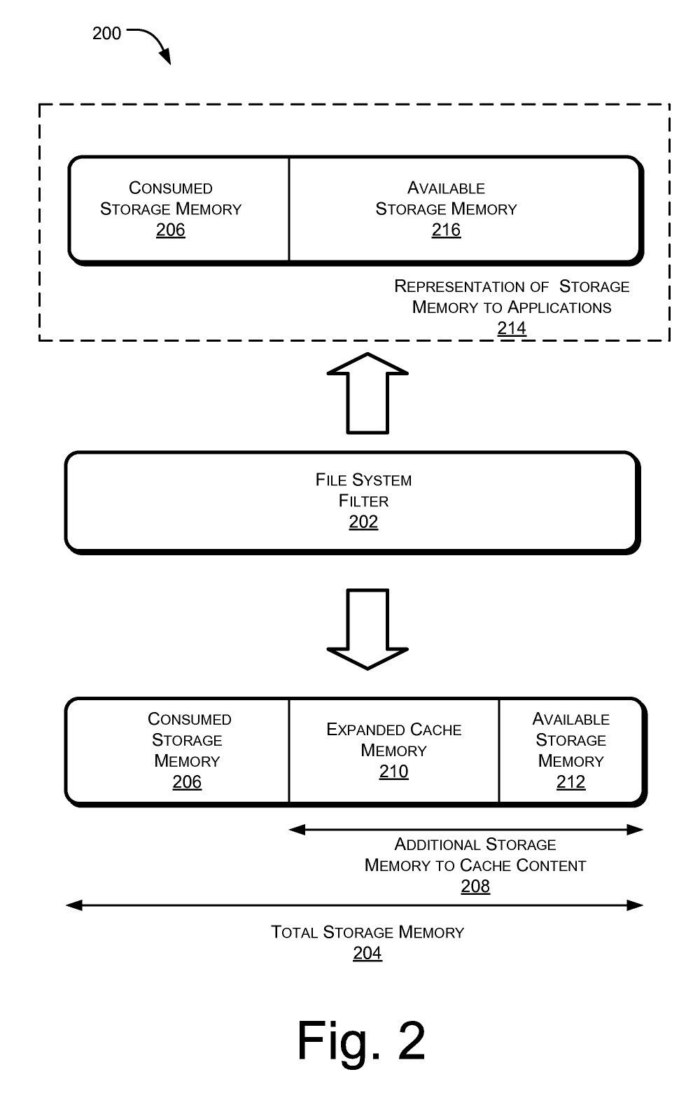

FIG. 2 illustrates a scheme to efficiently cache content in memory of a computing device.

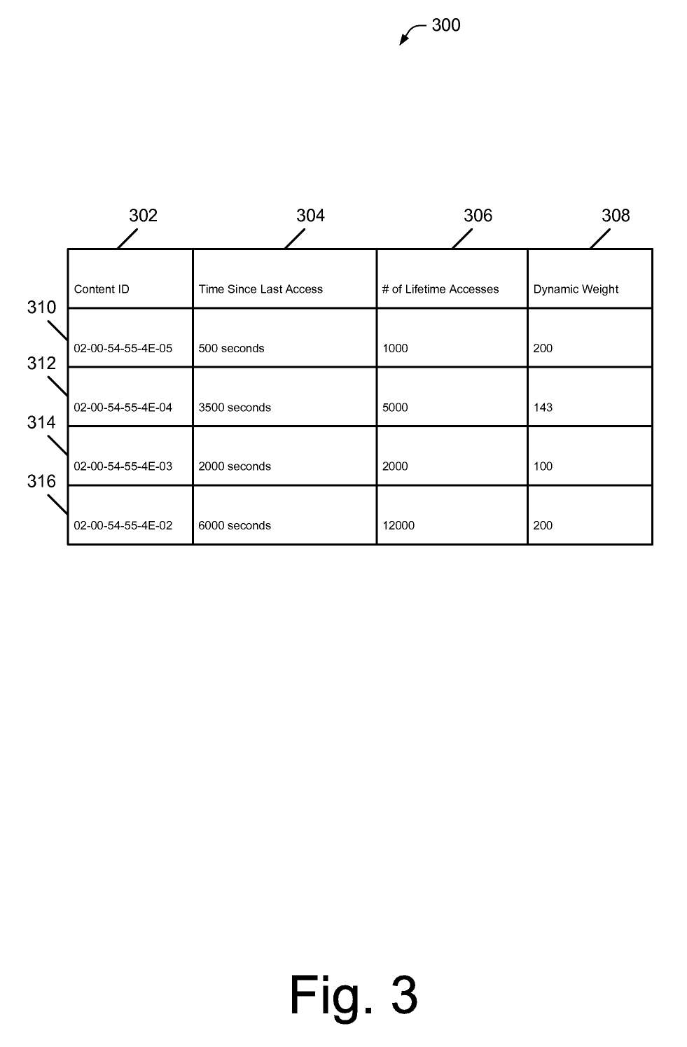

FIG. 3 illustrates an embodiment of a table including data utilized by a filter system filter to prioritize cached content.

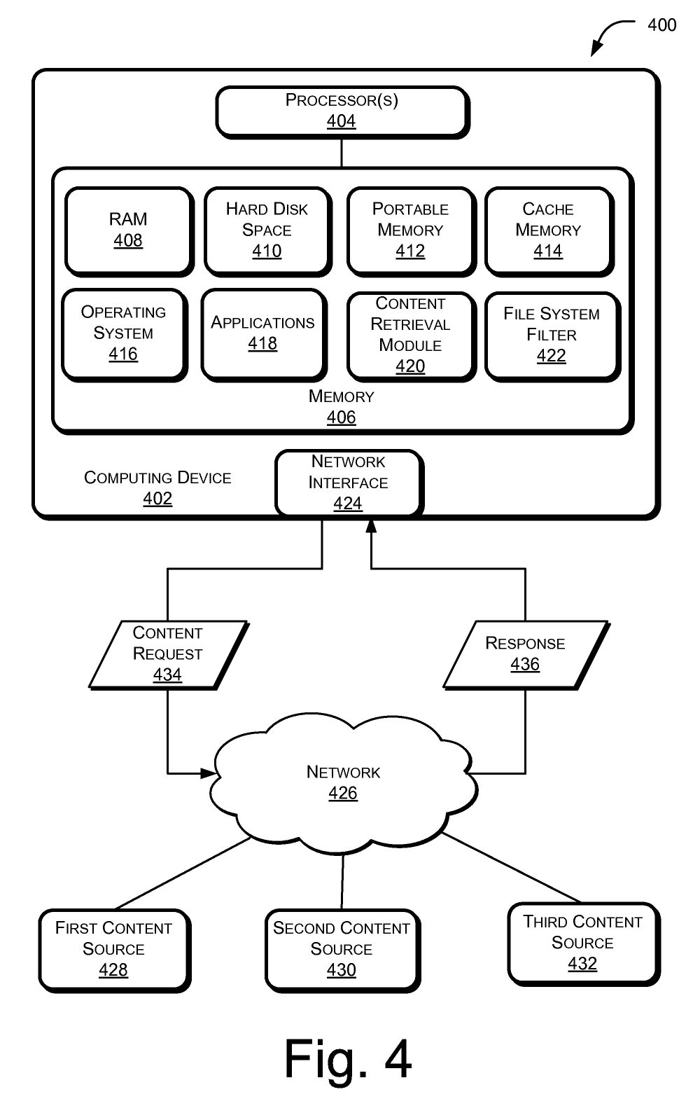

FIG. 4 illustrates a second embodiment of a system to dynamically cache and retrieve content.

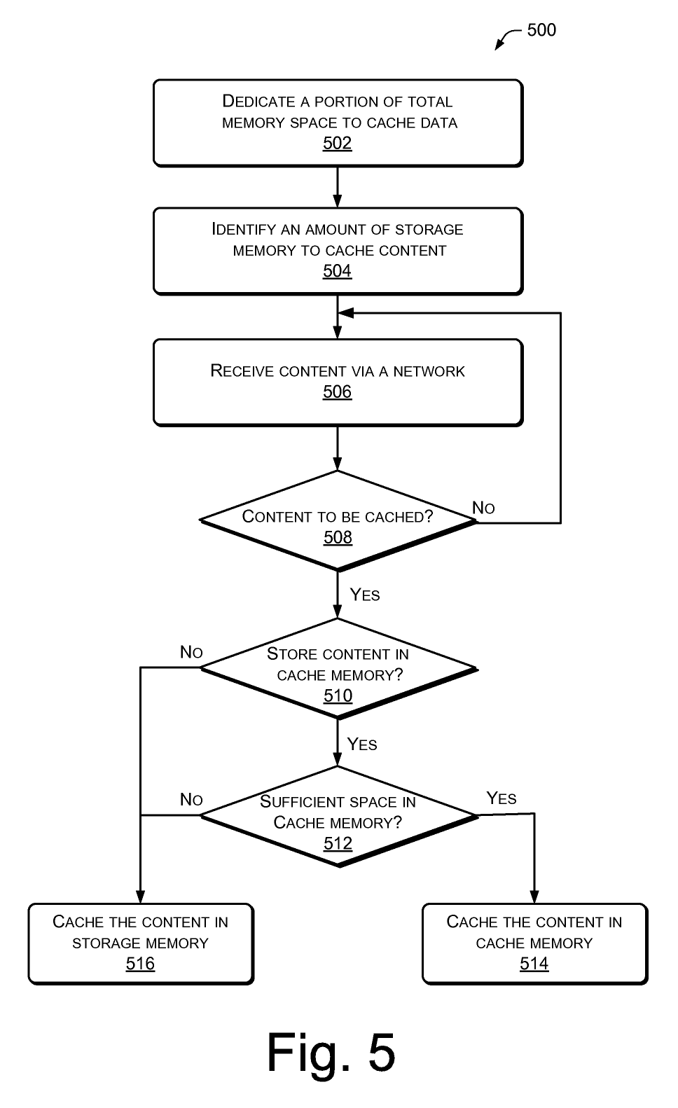

FIG. 5 is a flow diagram of a method to cache content in either cache memory of a computing device or in additional memory space of the computing device.

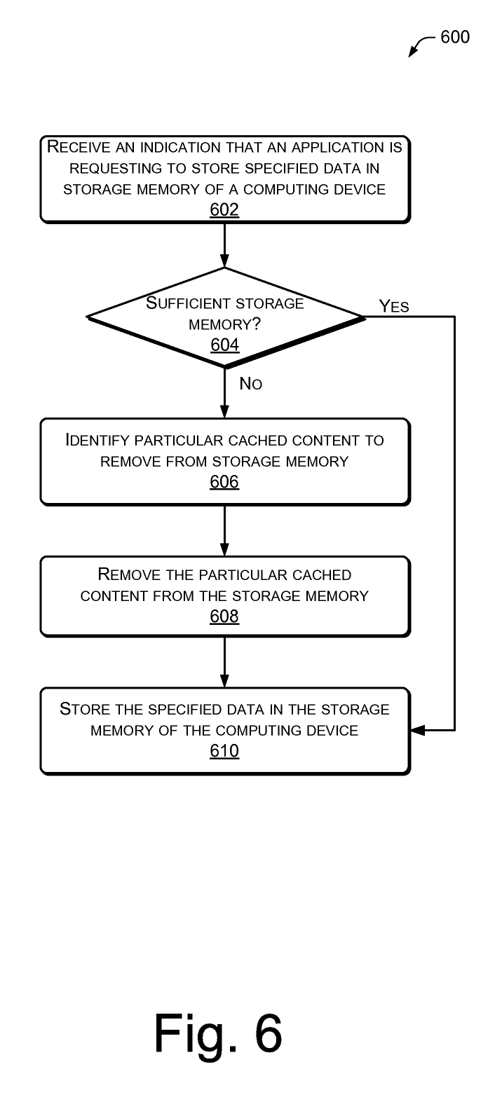

FIG. 6 is a flow diagram of a method to determine whether sufficient storage memory of a computing device is available to store content as requested by an application and to remove cached content from storage memory of the computing device when insufficient storage memory is available to store the content.

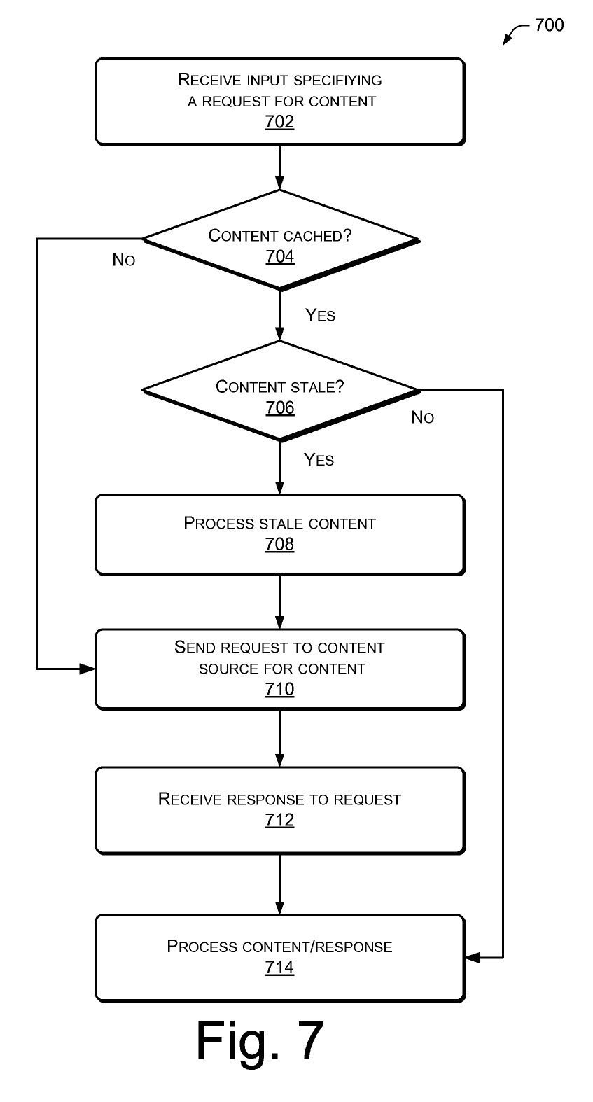

FIG. 7 is a flow diagram of a method to retrieve stale content from a cache while retrieving fresh content.

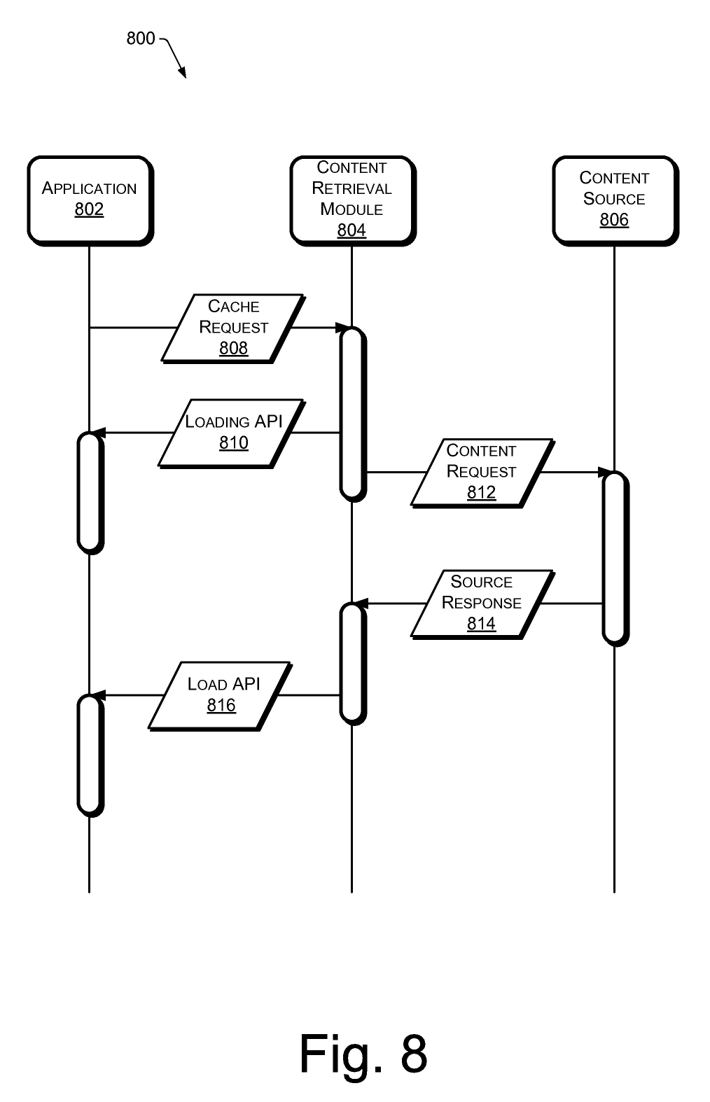

FIG. 8 is data flow between an application, a content retrieval module, and a content source to retrieve data requested by the application.

While the features of the invention may be modified, specific embodiments are shown and explained by way of example in the drawings. The drawings and detailed description are not intended to limit the features of the invention to the particular form disclosed, and instead the intent is to cover all modifications, equivalents, and alternatives falling within the spirit and scope of the features of the invention as defined by the claims.

### DETAILED DESCRIPTION

FIG. 1 illustrates a system 100 to dynamically cache and retrieve content. The system 100 includes a computing device 102. The computing device 102 may be a personal computer, a laptop computer, a personal digital assistant (PDA), a portable gaming device, a wireless communication device, such as a smart phone or mobile handset, a set-top-box, a game console, a portable music player, a router, a household appliance, a personal item, such as a wristwatch, an electronic picture frame, a netbook, other network connected devices, other browsing devices, etc., or any combination thereof. The computing device 102 communicates with one or more content sources 104 via a network 106.

The computing device 102 includes applications 108, system software 110, such as an operating system, and memory 112. The applications 108 may utilize the system software 110 to retrieve particular content from the content sources 104. For example, a browser application may utilize the system software 110 to retrieve web pages from a web server. Additionally, the applications 108 may utilize the system software 110 to store content in the memory 112. To illustrate, a music player application may utilize the system software 110 to download and store an audio file in the memory 112. The system software 110 may also retrieve executable application data from the content sources 104 in response to a request to execute a particular application 108, such as in a paging context. Further, the applications 108 may utilize the system software 110 to access data of the memory 112. In a particular implementation, a browser application may utilize the system software 110 to retrieve webpage content that was previously obtained from a web server during execution of a prior instance of the browser application.

The system software 110 includes a file system filter 114 to manage the caching of content in the memory 112. Further, the system software 110 includes one or more content retrieval application programming interfaces (APIs) 116 to retrieve cached content from the memory 112. Although FIG. 1 shows that the system software 110 includes the file system filter 114 and the content retrieval APIs 116, the file system filter 114 and/or the content retrieval APIs 116 may be implemented separate from the system software 110. For example, the file system filter 114 and/or the content retrieval APIs 116 may be included in an application development platform of the computing device 102.

The memory 112 includes cache memory 118 that is dedicated to temporarily caching content. The cache memory 118 may be designated to cache content of the applications 108 by the manufacturer of the computing device 102, by a user of the computing device 102, by the system software 110, or a combination thereof. The cache memory 118 may include volatile memory, such as random access memory, non-volatile memory, such as flash memory, or a combination thereof.

The cache memory 118 may cache content generated locally by the applications 108. For example, the locally generated cached content may be stored in the cache memory 118 while being utilized by the application generating the content or until a current instance of the application closes. For example, a word processing application may generate one or more versions of a document as the document is being drafted and the word processing application may request that the system software 110 caches at least one of the versions of the document in the cache memory 118 until the word processing application closes the document or until the application closes.

Additionally, the cache memory 118 may cache content generated remotely and retrieved from the content sources 104. In particular, the cache memory 118 may include remotely generated cached content obtained from the content sources 104 in response to a request for the content by one of the applications 108 To illustrate, a web browser application may request a webpage from a web server and after providing the webpage content to the web browser application, the system software 110 may store at least a portion of the webpage content in the cache memory 118 for subsequent use by the web browser application or by another instance of the web browser application executed at a later time. In another illustration, a particular application 108 may require a relatively large amount of memory space to store the executable code of the particular application 108. In this illustration, the system software 110 may retrieve chunks of executable data of the particular application 108 from one or more of the content sources 104 and cache the chunks in the cache memory 108 as an instance of the particular application 108 is executed on the computing device 102. At least a portion of the cached chunks of the particular application 108 may remain in the cache memory 118 for use by subsequent instances of the particular application 118. In some implementations, although, the applications 108 may request to retrieve particular content from the content sources 104, the applications may not explicitly request that the particular retrieved content is stored in the cache memory 118.

In addition, the memory 112 includes storage memory 120 that persistently stores data that the applications 108 have explicitly requested to be stored in the storage memory 120. The content requested to be stored in the storage memory 120 by the applications 108 may be referred to in this document as “application storage content.” The storage memory 120 may include non-volatile storage memory. For example, in some implementations, the storage memory 120 may include hard disk space and/or flash memory of the computing device 102. In a particular implementation, the storage memory 120 includes a flash memory stick inserted into a port of the computing device 102.

The storage memory 120 may also include expanded cache memory 122. The expanded cache memory 122 represents an amount of the storage memory 120 that is caching content. To illustrate, at a given time, a portion of the storage memory 120 may be utilized to hold application storage content, while an additional portion of the storage memory 120, that is the expanded cache memory 122, is utilized to cache locally generated content and/or remotely generated content retrieved from the content sources 104. Further, the storage memory 120 may include free space that is available to hold application storage content, locally generated cached content, remotely generated cached content, or a combination thereof.

In an illustrative implementation, the file system filter 114 manages the caching of locally generated content and/or remotely generated content in the cache memory 118 and in the storage memory 120. In particular, the file system filter 114 identifies free space of the storage memory 120 by identifying portions of the storage memory 120 that are not consumed. Consequently, when a specified amount of the cache memory 118 is consumed, such as when the cache memory 118 is full, the file system filter 114 may cache locally generated content, remotely generated content, or a combination thereof, in the free space of the storage memory 120.

Although the file system filter 114 may cache locally generated content and remotely generated content in the storage memory 120, the file system filter 114 represents to the applications 108 that the expanded cache memory 122 is still available to hold application storage content. For example, a download application may request to store data in the storage memory 120 that is downloaded from a particular content source 104, such as an audio or video file. In this example, the file system filter 114 represents to the download application that all of the free space of the storage memory 120 is available to store the downloaded file, even though at least a portion of the storage memory 120 is consumed by the expanded cache memory 122. In some instances, the file system filter 114 may remove at least a portion of the expanded cache memory 122 when the storage memory 120 does not include sufficient available space to store the content as requested by the application. In some implementations, locally generated cached content and/or remotely generated cached content in the storage memory 120 may be removed from the expanded cache memory 122 by the file system filter 114 according to a first in first out (FIFO) scheme. In other implementations, the file system filter 114 may utilize a weighting algorithm to prioritize the data of the expanded cache memory 122 to determine particular content to remove. Thus, portions of the storage memory 120 may be dynamically allocated as expanded cache memory 122 when the storage memory 120 includes space available to cache locally generated content and remotely generated content and portions of the expanded cache memory 122 may be dynamically re-allocated as storage memory 120 when additional space of the storage memory 120 is needed to store content as requested by the applications 108. In this way, the file system filter 114 may increase the efficiency of the amount of the storage memory 120 that is available to cache locally generated content and remotely generated content without sacrificing space of the storage memory 120 that is available to store content as requested by the applications 108.

Further, the file system filter 114 may remove content of the cache memory 118 to provide sufficient space for caching content received by the computing device 102. For example, a web browser application may request webpage content from one of the content sources 104. Continuing with this example, the file system filter 114 may desire to cache the webpage content after receiving the webpage content from the respective content source 104. In some instances, a specified amount of the cache memory 118 may be consumed and, therefore, the cache memory 118 is unable to cache the webpage content. Additionally, the storage memory 120 may not include sufficient free space to cache the webpage content. The file system filter 114 may then prioritize the content cached in the cache memory 118, the content of the expanded cache memory 122, or a combination thereof, according to a weighting scheme to identify content to be removed. Accordingly, the file system filter 114 removes content of the cache memory 118 and/or the expanded cache memory 122 with the lowest priority until enough space is available to cache the webpage content requested by the web browser application.

In another illustrative embodiment, the content retrieval APIs 116 may be executed to retrieve cached content from the memory 112, such as the cache memory 118, the expanded cache memory 122, or a combination thereof. In some implementations, a particular content retrieval API 116 may be executed to obtain remotely generated cached content from the memory 112 when one of the applications 108 sends a request for content to one of the content sources 104. The content retrieval APIs 116 may also provide requested content to one of the applications 108 in response to receiving the content from one of the content sources 104. For example, in a particular implementation, a web browser application may request a webpage from a web server. In response to this request, the content retrieval APIs 116 may determine whether a version of the webpage is cached in the cache memory 118 or in the expanded cache memory 122. In some implementations, when a version of the webpage is stored in the cache memory 118 or in the expanded cache memory 122, the content retrieval APIs 116 may provide the version of the webpage stored in the cache memory 118 or the expanded cache memory 122 to the web browser application, even if the version of the webpage is stale. For example, when a connection between the computing device 102 and the network 106 is slow or broken, a cached, but stale version of the webpage may be provided to the web browser application. Additionally, the system software 110 may be retrieving a fresh version of the webpage from the web server as the stale version of the webpage is provided to the web browser application. In this way, the content retrieval APIs 116 may enhance the experience of a user of the computing device 102 by decreasing any delays in the time between requesting content and accessing the requested content, while still providing fresh content when necessary. In addition, the content retrieval APIs 116 may enhance the experience of a user of the computing device 102 by decreasing user frustration that may result from the absence of a response to a request for content caused by a broken network connection.

FIG. 2 illustrates a scheme 200 to efficiently cache content in memory of a computing device. The scheme 200 may be utilized by a computing device, such as the computing device 102 of FIG. 1. The scheme 200 includes a file system filter 202 to manage the caching of data at a computing device. The file system filter 202 determines a total amount of storage memory 204 of a computing device to store data in response to requests from one or more applications of the computing device. The total storage memory 204 may include hard disk space, flash memory, portable external memory devices coupled to the computing device, external memory devices coupled to the computing device, or a combination thereof. The total storage memory 204 includes consumed storage memory 206. The consumed storage memory 206 includes at least a portion of the total storage memory 204 that stores data at any given time. For example, the consumed storage memory 206 may include computer-readable instructions of applications of a computing device, data generated by the applications, data utilized by the applications, or a combination thereof. The data of the consumed storage memory 206 may also be referred to in this document as “application storage content.”

The total storage memory 204 also includes additional storage memory to cache content 208. The additional storage memory to cache content 208 may include expanded cache memory 210. The expanded cache memory 210 may include content generated locally by applications of the computing device, where the applications have requested to cache the locally generated content in the total storage memory 204. In addition, the expanded cache memory 210 may include content generated remotely by a number of content sources in communication with the computing device. In some implementations, the file system filter 202 may cache locally generated content and/or remotely generated content in the total storage memory 204 when a specified amount of the cache memory of a computing device has been consumed. Additionally, the file system filter 202 may cache locally generated content and/or remotely generated content in the total storage memory 204 for an application that has not been allocated an amount of the cache memory of the computing device. For example, a user of a computing device may download an application or create an application that has not been allocated an amount of the cache memory. The file system filter 202 may store locally generated content, remotely generated content, or a combination thereof, utilized by this application in the total storage memory 204 as expanded cache memory 210 for faster retrieval by this application of locally generated cached content and/or remotely generated cached. The expanded cache memory 210 may include one or more files and may consume all or a portion of the additional storage memory to cache content 208.

The additional storage memory to cache content 208 also may include available storage memory 212. The filter system filter 202 may cache further content in the available storage memory 212. For instance, as applications of the computing device request to cache additional locally generated content or further remotely generated content is received from a content source, the file system filter 202 may cache the additional locally generated content and/or the further remotely generated content in the available storage memory 212 to provide faster access to the content.

The additional storage memory to cache content 208 may be a dynamic value that is monitored by the file system filter 202. For example, the file system filter 202 may determine that as hard disk space of a computing device is consumed, the additional storage memory to cache content 208 consequently decreases. In another example, the file system filter 202 may identify insertion of a flash memory stick in a port of the computing device and determine that the additional storage memory 208 has increased based on an amount of memory space that is available on the flash memory stick. Additionally, as the additional storage memory to cache content 208 changes, the file system filter 202 may add or remove content of the expanded cache memory 210 accordingly. To illustrate, when a flash memory stick is removed from a port of a computing device, the additional storage memory to cache content 208 may decrease to an amount that is less than the amount consumed by the expanded cache memory 210. In this illustration, the file system filter 202 may remove at least a portion of the expanded cache memory 210 to account for the decrease in the additional storage memory to cache content 208. In another illustration, when a flash memory stick is inserted into a port of the computing device, the file system filter 202 may cache content in any available storage memory space of the flash memory stick.

Although the file system filter 202 caches content in the additional storage memory to cache content 208, the file system filter 202 provides a representation of storage memory 214 to applications of the computing device indicating that the additional storage memory to cache content 208 comprises available storage memory space. In a particular implementation, the representation of memory space to the applications 214 includes consumed storage memory 206. The representation of memory space to the applications 214 also includes available storage memory 216. The available storage memory 216 may represent the same storage memory space as the storage memory space occupied by the additional storage memory to cache content 208. Thus, even though content may be stored in the available storage memory 216 as expanded cache memory 210, the file system filter 202 represents to applications of the computing device that the memory space consumed by the expanded cache memory 210 is still available to store content as requested by the applications. For example, a music player application may request to download audio content from a content source. In response to receiving confirmation of the download, the file system filter 202 represents to the music player application that an amount of memory space equivalent to the additional storage memory to cache content 208 is available to store the download, although the expanded cache memory 210 may be stored in at least a portion of the additional storage memory to cache content 208. In this way, the file system filter 202 maximizes the storage memory space of a computing device to cache content without limiting the amount of storage memory space available to the applications of the computing device to store content.

FIG. 3 illustrates an embodiment of a table 300 including data utilized by a filter system filter to prioritize cached content, such as locally generated cached content and/or remotely generated cached content. In particular implementations, a file system filter, such as the file system filter 114 of FIG. 1 or 202 of FIG. 2 may remove locally generated cached content, remotely generated cached content, or a combination thereof, that is cached in storage memory when an application is requesting to save content in storage memory of the computing device, but there is not enough storage memory to hold the content. The file system filter may employ a weighting algorithm to prioritize the locally generated content and/or remotely generated content cached in the storage memory to identify the particular content to remove from the storage memory in order to clear sufficient storage memory space for the content requested to be stored by the application.

The weighting algorithm may also be used to prioritize content of cache memory of the computing device. For example, in response to receiving content at the computing device that is to be cached in the cache memory, the file system filter may prioritize the existing content of the cache memory according to the weighting algorithm and remove lower priority content from the cache memory to clear sufficient space to cache the new content received at the computing device. In some instances, content of the cache memory and content cached in the storage memory may both be prioritized according to the weighting algorithm and cached content of the cache memory and/or the storage memory may be removed to provide sufficient space to cache higher priority content received at the computing device.

The table 300 includes data that may be utilized in a weighting algorithm to prioritize content cached in the storage memory or cache memory of a computing device. The table 300 includes a column 302 that includes content identification numbers. The content identification numbers may be utilized by the file system filter to identify each item of content cached in storage memory or cache memory. For example, when cached content includes webpage content, the content identification number may be a hash of the web address of the webpage. The table 300 also includes columns 304 and 306 that include data associated with each content item that may be utilized to calculate a dynamic weight that is shown in column 308. For example, the column 304 includes the time elapsed since a last access of a particular content item and the column 306 includes the number of lifetime accesses of the content item by the computing device or by a particular application. The table 300 also includes rows 310-316 that each includes data related to a respective content item.

In a particular implementation, the dynamic weight is calculated utilizing a formula of:

((100×Static Weight of # of Lifetime Accesses×# of Lifetime Accesses)/(Static Weight of Time Elapsed since Last Access×Time Elapsed since Last Access))

The static weight of the # of lifetime accesses and the static weight of time elapsed since last access may be assigned by an application utilizing the file system filter, by a user of the computing device, by an application development platform of the computing device, or a combination thereof. In the table 300, the static weight of # of lifetime accesses and the static weight of time elapsed since last access are set to 1, but these weights can be set to any desired value. In addition, the dynamic weight of each content item is classified as dynamic because the time since a last access of a particular content item and the number of lifetime accesses of a particular content item are changing over time.

In an illustrative implementation, when the file system filter needs to remove content cached in storage memory of the computing device, content of the cache memory of the computing device, or a combination thereof, the file system filter may access the table 300 and determine the content items with the lowest priority. The file system filter may then proceed to remove as many of the lowest priority content items as necessary from the storage memory and/or cache memory until sufficient memory space is available to hold the requested content. For example, as shown in the table 300, the content items of the row 312 and the row 314 have the lowest priority because the dynamic weight of the content item of the row 312 is 143 and the dynamic weight of the content item of the row 314 is 100. Thus, the file system filter would remove the content item of the row 314 first because this content item is associated with the lowest dynamic weight and then remove the content item of the row 312 because this content item has the next lowest priority of 143. If a further content item should need to be removed, the file system filter may employ tiebreaker criteria between the content item of the row 310 and the content item of the row 316 since these content items have the same dynamic weight of 200. For example, the file system filter may give the highest priority to the content item that has been most recently accessed. With respect to the table 300, the content item of the row 310 has been accessed more recently than the content item of the row 316. Accordingly, the file system filter would remove the content item of the row 316 before removing the content item of the row 310.

Although a particular example of a weighting algorithm has been described with respect to the table 300, any number of weighting algorithms can be used to prioritize content cached in storage memory. Further, each type of data item may be associated with a different type of weighting algorithm. For example, webpage content items may be prioritized according to one weighting algorithm, while video content items are prioritized according to a different weighting algorithm. Additionally, different content items may be prioritized against each other. To illustrate, webpage content items may be given a higher priority than video content items. Weighting algorithms may also be set by respective applications of a computing device, such that the file system filter executes one weighting algorithm when removing content cached in storage memory to make space for a music download application, while the file system filter executes another weighting algorithm when removing content cached in storage memory to make space for an email application.

Additionally, the weighting algorithm may accommodate a generalized caching policy, where the weighting algorithm is utilized to prioritize cached content. The prioritized cached content can be used to determine whether or not new content of a computing device should be cached with respect to currently cached content. The prioritized cached content can also be used to identify content to be removed from cache memory, expanded cache memory, or a combination thereof, to provide additional memory space to cache and/or store content. Further, an application developer, a user of the computing device, an operating system, or a combination thereof, may provide additional policies that override and/or supplement the weighting algorithm. For example, a user may indicate that video content received at the computing device is not to be cached. In another example, an application developer may stipulate that content received from a particular content source is to be given greater weight than content from other content sources. In addition, executable application data for one application may be assigned a higher priority than executable application data for another application. In some implementation, executable application data of a particular application may be assigned a higher priority because the particular application is utilized more frequently than other applications.

FIG. 4 illustrates a second embodiment of a system 400 to dynamically cache and retrieve content. The system 400 includes a computing device 402. The computing device 402 may include one or more processors 404. In addition, the computing device 404 includes memory 406 that is accessible to the one or more processors 404.

The memory 406 includes computer-readable storage media, such as random access memory 408, hard disk space 410, portable memory 412, such as a flash memory stick, and cache memory 414. The memory 406 may provide non-volatile and/or volatile storage of computer readable instructions, data structures, program modules, and other data. For example, the memory 406 includes an operating system 416, one or more applications 418, a content retrieval module 420, and a file system filter 422 that are executable by the one or more processors 404 to provide dynamic content caching and retrieval. The computing device 402 may also include other components that are not shown. For example, the computing device 402 may include a number of input/output device interfaces to communicate with input devices, such as a keyboard, a pointing device (e.g. a mouse), a microphone, a peripheral device (e.g. a scanner), or a combination thereof. The input/output device interfaces may also facilitate communications with output devices, such as one or more display devices, speakers, a printer, or a combination thereof.

The computing device 402 also includes a network interface 424 to facilitate communications via a network 426. The network 426 may include a local area network, a wide area network, such as a public switched telephone network (PSTN), a cable television network, a satellite network, a collection of networks, a public Internet Protocol (IP) network, a private IP network, or a combination thereof. Moreover, the network 426 may be wired, wireless, or a combination of the two.

The computing device 402 may communicate with content sources 428, 430, and 432 via the network 426. The content sources 428-432 may provide different types of content to the computing device 402. For example, the first content source 428 may include a web server that provides webpage content to the computing device 402. In another example, the second content source 430 may include an email server that provides email services to the computing device 402. Further, the third content source 432 may include a download server to provide audio and/or video files to the computing device 402. Additionally, one of the content sources 428-432 may provide executable application data to the computing device 402.

Content may be temporarily cached in the cache memory 414. The cache memory 414 may be dedicated to caching locally generated content as requested by the one or more applications 418. For example, the cache memory 414 may store a temporary copy of a word processing file. The cache memory 414 may also cache remotely generated content that is obtained from one of the content sources 428-432 and is to be utilized by a particular one of the applications 418. To illustrate, the cache memory 414 may cache webpage content retrieved by a web browser application from the first content source 428. Additional memory space may also be available to cache content, such as memory space of the RAM 408, memory space of the hard disk space 410, memory space of the portable memory 412, or a combination thereof.

Content cached at the computing device 402 may be stale or fresh. For example, content may be considered stale when a lifetime assigned to the content has expired. The lifetime may be assigned by a particular content source providing the content. Although content may be considered stale, the content may still be valid. To illustrate, stale content cached at the computing device 402 may be considered valid when the version of the content cached at the computing device 402 matches a most recent version of the content stored at the respective content source 428-432 providing the content. In addition, content may be considered fresh when the lifetime of the content has not expired.

In an illustrative implementation, a particular application 418 generates a content request 434 for specified content. In one example, a browser application may generate a request for webpage content. In another example, a music player application may generate a request to download audio content. In a further example, a particular application 418 may require additional executable application data and the particular application 418 may generate a request to retrieve the additional executable application data as needed.

In some instances, the content retrieval module 420 may be invoked before sending the content request 434 to a respective content source 428-432. For example, the content retrieval module 420 may be executable by the one or more processors 404 to determine whether a previously retrieved version of the requested content is cached at the computing device 402. In addition, one or more application programming interfaces (APIs) of the content retrieval module 420 may be called to obtain remotely generated content cached at the computing device 402, where the remotely generated content satisfies the content request 434. In particular, the content retrieval module 420 may include a first API that is executable by the one or more processors 404 to provide a stale version of the requested content to the requesting application 418 while the content retrieval module 420 retrieves a fresh version of the requested content from a respective content source 428-432. The first API may also be called, but return no data, when the content requested by the particular application 418 is not cached at the computing device 402 or when a fresh version of the requested content is cached at the computing device 402. The content retrieval module 420 may also include a second API to provide a fresh version of the requested content to the particular application 418. The fresh version of the requested content may be cached at the computing device 402 or retrieved from a particular content source 428-432.

When the specified content requested by the particular application 418 is not cached at the computing device 402 or when the specified content is cached, but stale, the content retrieval module 420 is executable by the one or more processors 404 to send the content request 434 to a respective content source 428-432 for the specified content. After receiving the content request 434 at the respective content source 428-432, the respective content source 428-432 may provide a response 436 to the computing device 402. In a particular example, when the content request 434 is sent to the first content source 428 for webpage content, the first content source 428 may provide the response 436 that includes a fresh version of the webpage content to the computing device 402. In another example, the first content source 428 may provide the response 436 that includes a lifetime extension of the specified content to the computing device 402 indicating that stale remotely generated content cached at the computing device 402 remains valid.

After receiving the response 436, the content retrieval module 420 may take a number of actions. For example, when the specified content requested by the particular application 418 is cached at the computing device 402 and the cached version of the specified content is stale, the second API of the content retrieval module 420 may be called with no data when the response 436 includes an extension of the lifetime of the specified content. Thus, in this example, stale content provided by the first API to the particular application 418 is valid. In another example, when stale remotely generated cached content is provided to the particular application 418 by the first API and the response 436 indicates that the stale content is invalid, the second API of the content retrieval module 420 may be called to provide the fresh version of the specified content received from one of the content sources 428-432 to the particular application 418 as an update to the stale version.

The manner in which stale content provided to the particular application 418 is updated may vary. In some instances, stale content may not be immediately updated upon receipt of a fresh version of the content at the computing device 402. For example, the first API of the content retrieval module 420 may provide a web browsing application with stale webpage content to show via a display device coupled to the computing device 402 in response to a request for the webpage content. When a fresh version of the webpage content is included in the response 436, the web browsing application may indicate to cache the fresh version of the webpage content because providing a fresh version of the content while a user of the computing device 402 is viewing the stale version of the webpage could be disrupting to the user. Alternatively, a pop-up window or dialog box may be displayed indicating that a fresh version of the webpage content has been received at the computing device 402 and the pop-up window/dialog box may include an option to view the fresh version of the webpage content. In other instances, the fresh version of the specified content may be provided to the particular application 418 requesting the content upon receipt of the specified content at the computing device 402. The manner in which a stale version of specified content is updated may depend on preferences specified by a user of the computing device 402, the particular application 418 requesting the content, an application development platform of the computing device 402, or a combination thereof.

In another illustrative implementation, the file system filter 422 may be executable by the one or more processors 404 to store content included in the response 436. In some instances, content included in the response 436 may be cached at the computing device 402 as remotely generated cached content. In other instances, the content included in the response 436 may be stored in storage memory of the computing device 402 in response to a storage request by the particular application 418 requesting the content. Thus, the file system filter 422 may be executable by the one or more processors 404 to determine whether or not to cache the specified content included in the response 436. To illustrate, the file system filter 422 may determine that the specified content of the response 436 includes webpage content from the first content source 428 that is to be cached. In another illustration, the file system filter 422 may determine that the specified content of the response 436 is an audio file from the third content source 432 and that a music player application has requested to store the audio file in storage memory of the computing device 402 after the download of the audio file has been confirmed. In yet an additional illustration, the response 436 may include executable application data requested by one of the application 418 and the requested executable application data may be cached at the computing device 402 during execution of an instance of the requesting application 418 and/or for future use by the requesting application 418.

When the file system filter 422 determines that the remotely generated content of the response 436 is to be cached, the file system filter 422 may then determine whether the cache memory 414 includes sufficient space to cache the specified content or whether the specified content is to be cached in other space of the memory 402, such as the RAM 408, the hard disk space 410, the portable memory 412, or a combination thereof. The file system filter 422 is executable by the one or more processors 404 to cache the specified remotely generated content in the cache memory 414 and/or in other space of the memory 406. In some instances, the file system filter 422 may remove other remotely generated cached content and/or locally generated cached content from the cache memory 414, from other memory space caching content, or a combination thereof, when the remotely generated content included in the response 436 has a higher priority than content currently cached in the memory 406.

Additionally, when an application 418 requesting the content of the response 436 provides a storage request to store the content in storage memory of the computing device 402, the file system filter 422 may determine whether or not content cached in storage memory needs to be removed in order to store the content of the response 436. For example, the file system filter 422 may cache content in the hard disk space 410 that is not otherwise dedicated to caching content. When the file system filter 422 receives an indication that a particular application 418 is requesting to store the content of the response 436 in the hard disk space 410, the file system filter 422 may determine whether or not sufficient hard disk space 410 is available to store the specified content. When the hard disk space 410 is sufficient to store the content, the file system filter 422 may be executable by the one or more processors 404 to store the specified content in the hard disk space 410. Otherwise, the file system filter 422 may be executable by the one or more processors 404 to identify particular content cached in the hard disk space 410 and remove the particular content to provide sufficient storage memory space to store the content of the response 436 in the hard disk space 410.

FIG. 5 is a flow diagram of a method 500 to cache content in either cache memory of a computing device or in storage memory of the computing device. The method 500 may be implemented via the computing device 102 of FIG. 1 or the computing device 402 of FIG. 4. In a particular example, the method 500 is implemented by executing computer readable instructions of the file system filter 422 of FIG. 4.

The method 500 begins at 502 with dedicating a portion of total memory space of a computing device to cache data. The memory space of a computing device that is fully dedicated to temporarily caching data is referred to in this document as “cache memory.” For example, a manufacturer of the computing device or a user of the computing device may decide to dedicate a particular portion of memory space of the computing device to caching data. In addition, an operating system of the computing device may allocate specified portions of the memory space to one or more applications of the computing device to cache data of the respective applications. In some implementations, each application of the computing device may be allocated approximately the same amount of memory space, while in other implementations, applications of the computing device may be allocated different portions of memory space depending on the requirements of the particular application. For example, a web browser application may be allocated more memory space to cache content than an email application or a word processing application.

At 504, an amount of storage memory that may be used to cache content is identified. In an illustrative implementation, a file system filter, such as the file system filter 106 of FIG. 1, 202 of FIG. 2, or 422 of FIG. 4, may identify storage memory of the computing device that can be utilized to cache content. For example, the file system filter may identify a portion of hard disk space of the computing device, flash memory space of the computing device, memory space associated with portable memory devices, or a combination thereof, that can be utilized to cache content. In some implementations, the file system filter may also identify space of other memory of the computing device, such as RAM, that can be utilized to cache content.

At 506 content is received at the computing device via a network. In one implementation, the content is webpage content requested by a web browser application. In another implementation, the content is executable application data requested by a particular application of the computing device. At 508, the file system filter determines whether or not the content is to be cached at the computing device. In some instances, certain types of content may be cached at the computing device, while others are not. For example, webpage content, or certain portions of the webpage content may be cached at the computing device, while some download content is stored in storage memory of the computing device. When content is not to be cached at the computing device due to the type of the content, such as download content, the content may be stored in storage memory of the computing device and the method 500 returns to 506. In other instances, determining whether the content is to be cached includes determining whether cache memory, storage memory, or a combination thereof, includes sufficient space to cache the content. When a specified amount of the memory space of the computing device to cache content is consumed, the file system filter may determine a priority of the content received via the network with respect to content cached in the cache memory and/or content cached in the storage memory and decide whether or not to cache the content received via the network according to the priority of the content. For example, when the content received via the network has a lower priority than the content already cached at the computing device, then the content received via the network may be discarded and the method 500 returns to 506. In another example, when the content received via the network has a higher priority than content already cached at the computing device, the content received via the network may be cached in cache memory, storage memory, or a combination thereof, at the computing device after some of the currently cached content having a lower priority is removed. When the content received via the network is to be cached at the computing device, the method proceeds to 510

At 510, the file system filter determines whether the content is to be cached in the portion of the memory space dedicated to caching content, that is, in the cache memory. For example, certain applications of the computing device, such as newly downloaded applications or applications created by a user of the computing device, may not be allocated space in cache memory to temporarily cache content. When the content is not to be stored in cache memory, the method proceeds to 516. Otherwise, the method moves to 512. At 512, the file system filter determines whether there is sufficient space in the cache memory to cache the content. If the cache memory has sufficient space to cache the content, the method advances to 514 where the content is cached in the cache memory. When the cache memory space is not sufficient to store the content, the method moves to 516 where the file system filter caches the content in storage memory. In some instances, the storage memory does not include enough space to cache the content and the file system filter may invoke a prioritization algorithm to determine whether content should be removed from the storage memory to make space for the content or whether the content should not be cached. In some implementations, the content may also be cached in memory other than storage memory, such as RAM, when the cache memory does not include sufficient space to store the content.

FIG. 6 is a flow diagram of a method to determine whether sufficient storage memory of a computing device is available to store content as requested by an application and to remove cached content from storage memory of the computing device when insufficient storage memory is available to store the content. The method 600 may be implemented on a computing device, such as the computing device 102 of FIG. 1 or the computing device 402 of FIG. 4. In a particular example, the method 600 is implemented by executing computer readable instructions of the file system filter 422 of FIG. 4.

The method begins at 602 with receiving an indication by a file system filter of the computing device that a particular application is requesting to store specified content in storage memory of the computing device. For example, the application may request to store an audio file, a text file, a video file, or a combination thereof, downloaded from a content source in storage memory. The storage memory may include hard disk space, flash memory space, space of portable memory devices, such as a flash memory stick coupled to the computing device, or a combination thereof. The memory of the computing device may also include cache memory dedicated to caching content of the one or more applications. In addition, the memory of the computing device may include additional memory space to cache remotely generated content and/or locally generated content, such as the storage memory and/or RAM.

At 604, the method 600 includes determining, by the file system filter, whether the memory includes sufficient storage memory to store the specified data. The file system filter may determine whether sufficient storage memory is available to store the content by determining an amount of memory space to be utilized to store the content and comparing the amount to be utilized to store the content with available storage memory. When the memory of the computing device does include sufficient storage memory to store the specified data, the method proceeds to 610. Otherwise, the method advances to 606.

At 606, the file system filter identifies particular cached content to remove from the storage memory. In some implementations, the file system filter may prioritize content cached in the storage memory in order to identify the cached content to remove from the storage memory. The content cached in the storage memory may be prioritized based on one or more criteria and a weighting scheme utilizing the one or more criteria. The weighting scheme utilized by the file system filter to prioritize the content cached in the storage memory and the criteria of the weighting scheme may be specified by the particular application requesting to store the content, an operating system of the computing device, a user of the computing device, an application development platform of the computing device, or a combination thereof. In some implementations, the weighting scheme information, criteria, or a combination thereof, may be received at the computing device from a remote server via the network and cached in cache memory or cached in storage memory. The weighting scheme and/or criteria may also be stored in local memory of the computing device. The weighting scheme information and criteria may be updated periodically as the weighting scheme and/or criteria change over time. For example, an application developer may obtain data indicating that users of the application use the application in a particular manner and correspondingly adjust the weighting scheme to reflect the manner in which the application is utilized.

Upon identifying a particular cached content item to remove from the storage memory, the file system filter may determine whether the content item consumes more or less memory space than the content to be stored in the storage memory of the computing device. If the content item to be removed consumes less memory space, then the file system filter may identify one or more additional cached content items to remove to provide sufficient storage memory for the specified content to be stored in the storage memory of the computing device.

At 608, the file system filter removes the particular cached content from the storage memory and at 610, the file system filter stores the specified content in at least a portion of the storage memory space previously occupied by the content removed. In some implementations, the file system filter may remove the entire amount of data of the content items to be removed before storing the specified content in the storage memory. In other implementation, the file system filter removes a portion of the cached content to be removed as an equivalent portion of the specified data is received at the computing device. Additional portions of the cached content in the storage memory may be removed as additional portions of the specified content are received at the computing device. In a particular illustrative implementation, a video player application may download video content from a website and request to store the video content in the storage memory of the computing device. In response to receiving a certain amount of the video content at the computing device, such as 1 MB, the file system filter may remove 1 MB of cached content from the storage memory. As the computing device receives additional portions of the video content, such as additional 1 MB portions, the file system filter may subsequently remove corresponding 1 MB portions of the additional cached content until all of the specified content has been stored in the storage memory of the computing device.

FIG. 7 is a flow diagram of a method to retrieve stale content from a cache while retrieving fresh content. The method 700 may be implemented by the computing device 102 of FIG. 1 or the computing device 402 of FIG. 4. In a particular example, the method 700 is implemented by executing computer readable instructions of the content retrieval module 420 of FIG. 4.

The method 700 begins at 702 with receiving input specifying a request for content. For example, a user of a computing device may request to view a particular webpage. At 704, the computing device determines whether the content is cached at the computing device. To illustrate, the computing device may determine whether the requested content is cached in cache memory of the computing device, where the cache memory is dedicated to caching content of applications of the computing device. The computing device may also determine whether the requested content is cached in additional memory space to cache content, such as storage memory. When the content is not cached at the computing device, the method proceeds to 710. Otherwise, the method moves to 706.

At 706, the computing device determines whether the content cached at the computing device is stale, that is, the computing device determines whether the lifetime of the content has expired or not. In a particular implementation, each time content is cached at the computing device, the content may be assigned a particular amount of time that the content is considered to be valid. Upon expiration of this amount of time, the computing device may consider the content to be stale. When the content is not stale, the method 700 proceeds to 714 and when the content is stale, the method 700 advances to 708.

At 708, the computing device processes the stale content, that is, the stale content is provided to the application requesting the content. In some implementations, the stale content is provided to the application via a particular application programming interface (API). In a particular example, when the requested content is a webpage and a cached, but stale copy of the webpage is stored at the computing device, a browser application of the computing device may provide the stale copy of the webpage to a display of the computing device. In this way, the experience of a user of the computing device is enhanced by not having to wait for content to be provided, especially in situations where the data connection between the content source and the computing device is slow or subject to frequent broken connections.

At 710, the method 700 includes sending a request to a content source for the requested content. For example, the computing device may send a request to a web server for content of a requested webpage. At 712, the computing device receives a response to the request. In some implementations, the computing device may receive an extension of the lifetime of the requested content. In particular, when content is considered stale by the computing device, the computing device may receive an indication from the content source that although the lifetime of the content has expired with respect to the computing device, the content is still valid. To illustrate, when a request is sent to a content source for a webpage and the computing device considers the webpage to be stale, the computing device may receive an extension of the lifetime of the webpage from the content source specifying that the content of the webpage is still valid. In other implementations, the computing device may receive new content from the content source in response to the request. For example, when the requested content is not cached at the computing device or when stale content cached at the computing device is no longer valid, the computing device may receive an updated version of the content from the content source, such as an updated webpage.

At 714, the requested content or the response to the request for content is processed by the computing device. For example, when the computing device receives an extension of the lifetime of the content, the computing device may update the lifetime of the content. In another example, when the computing device receives a new version of the content, the new version of the content may be cached at the computing device for future reference or the new version of the content may be provided to the application requesting the content. The fresh version of the content may be provided to the application via a different API than the API providing the stale content to the application. In a further example, the application requesting the content may also request to have the content stored in storage memory of the computing device.

FIG. 8 illustrates data flow between an application 802, a content retrieval module 804, and a content source 806 to retrieve data requested by the application 802. The application 802 may be an application 108 of the computing device 102 of FIG. 1 or an application 418 of FIG. 4. Additionally, the content retrieval module 804 may be the content retrieval module 420 of FIG. 4. The application 802 and the content retrieval module 804 may be executed by a computing device, such as the computing device 102 of FIG. 1 and the computing device 402 of FIG. 4. The content source 806 may be one of the content sources 104 of FIG. 1 or one of the content sources 428-432 of FIG. 4.

In the particular implementation, shown in FIG. 8, the application 802 may generate a cache request 808 to retrieve content from memory space of a computing device, such as cache memory or storage memory. The content retrieval module 804 may call a loading API 810 in response to the cache request 808. When the particular content is cached at the computing device and the particular content is stale, the loading API 810 returns the stale content to the application. When the particular content is cached at the computing device and is not stale or when the particular content is not cached at the computing device, the loading API 810 may optionally be called with no data returned to the application. Whether or not the loading API 810 is called in a particular situation may depend on preferences indicated by the application 802, by an application development platform of a computing device, by a user of a computing device, by an operating system of a computing device, or a combination thereof. In some instances, the loading API 810 may be called when a connection between a computing device and a communication network is broken. Thus, content will be provided to the application 802 even when fresh content is not available or when a connection between the computing device and a content source is not available due to a broken network connection. Further, when the connection between the computing device and the communication network is broken, the content retrieval module 804 may place requests for content into a queue until the network connection is restored.

A content request 812 is sent to the content source 806 by the content retrieval module 804 to obtain the content requested by the application 802 in the cache request 806. In some implementations, the content request 812 may include an entity tag of the requested content. The content request 812 may be sent to the content source 806 when the requested content is not cached at the computing device or when the particular content is cached, but the cached content is stale. A source response 814 is sent from the content source 806 in response to the content request 812. In some instances, the source response 814 includes an extension of the lifetime of the requested content. In other instances, the source response 814 may include a fresh version of stale data cached at the computing device.

A load API 816 may also be called by the content retrieval module 804. The load API 816 provides requested content to the application 802. In some instances, the load API 816 may be called when a fresh version of the requested content is cached at the computing device. In these instances, the load API 816 may be called without first calling the loading API 810 or without sending the content request 812 to the content source 806. In other instances, the load API 816 is called when an invalid version of the requested content is cached at the computing device or when the requested content is not cached at the computing device. In particular, when the content retrieval module 804 receives the source response 814 that includes a fresh version of the requested content, the load API 816 may be called to provide the fresh version of the requested content included in the source response 814 to the application 802. The load API 816 may also optionally be called with no data when the lifetime of requested, stale content is extended.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
receiving an indication, by a computing device executing system software and one or more applications, that a particular application is requesting to store specified data in storage memory of the computing device, wherein the storage memory includes cached content;
determining, by the computing device, whether the storage memory includes sufficient space to store the specified data in response to receiving the indication;
determining, by the computing device, whether to remove at least a portion of the cached content from the storage memory when the storage memory includes insufficient space to store the specified data;
identifying, by the computing device, particular cached content to remove from the storage memory when at least a portion of the cached content is to be removed from the storage memory;
removing, by the computing device, the particular cached content from the storage memory; and
storing, by the computing device, the specified data in the storage memory of the computing device.

2. The method of claim 1, further comprising prioritizing the cached content of the storage memory, by the computing device, to identify the particular cached content to remove from the storage memory.

3. The method of claim 2, wherein the cached content of the storage memory is prioritized based on one or more criteria and a weighting scheme including the one or more criteria.

4. The method of claim 3, wherein the weighting scheme is specified by the particular application, an operating system of the computing device, a user of the computing device, an application development platform of the computing device, or a combination thereof.

5. The method of claim 3, wherein the computing device receives the one or more criteria, the weighting scheme, or a combination thereof, from a remote server, from local memory, or a combination thereof.

6. The method of claim 1, wherein determining whether to remove at least a portion of the cached content of the storage memory comprises determining, by the computing device, an amount of the storage memory to be utilized to store the specified data.

7. The method of claim 1, wherein the computing device includes cache memory, and wherein content is cached in the storage memory when the cache memory is full.

8. An apparatus comprising:
a processor;
one or more applications;
cache memory including cached content;
storage memory including application storage content and expanded cache memory, wherein the application storage content is stored in the storage memory in response to requests from the one or more applications, and wherein the expanded cache memory includes additional cached content; and
system software executable by the processor to represent to the one or more applications that the expanded cache memory is available to store additional application storage content.

9. The apparatus of claim 8, wherein the system software is executable by the processor to:
receive content via a network; and
determine whether the content is to be cached in the cache memory, the storage memory, or a combination thereof.

10. The apparatus of claim 9, wherein determining whether the content is to be cached includes determining whether sufficient space is available in the cache memory, the storage memory, or the combination thereof, to cache the content.

11. The apparatus of claim 10, wherein the system software is executable by the processor to:
determine a priority of the content with respect to at least one of the cached content and the additional cached content when the cache memory, the storage memory, or the combination thereof, does not include sufficient space to cache the content; and
remove particular content from the cache memory, the storage memory, or the combination thereof, when the particular content has a lower priority than the content received via the network.

12. The apparatus of claim 8, wherein the system software is executable by the processor to:
identify a change in an amount of the storage memory;
remove particular additional cached content from the expanded cache memory when the amount of storage memory decreases; and
cache further content in the storage memory when the amount of storage memory increases.

13. The apparatus of claim 12, wherein identifying the change in the amount of storage memory includes identifying insertion or removal of a portable memory device at the apparatus.

14. One or more computer-readable storage media including instructions that, when executed by a processor of a computing device, perform acts comprising:
receiving input specifying a request for content from an application;
determining whether the content is cached at the computing device;
determining whether the content is stale when the content is cached at the computing device;
providing the content to the application via a particular application programming interface (API) when the content is cached at the computing device and when the content is stale; and
sending a request to a content source for the content when the content is stale.

15. The one or more computer-readable storage media of claim 14, wherein the acts further comprise receiving an extension of a lifetime of the content from the content source.

16. The one or more computer-readable storage media of claim 14, wherein the acts further comprise receiving a fresh version of the content from a content source.

17. The one or more computer-readable storage media of claim 16, wherein the acts further comprise caching the fresh version of the content in response to receiving the fresh version of the content.

18. The one or more computer-readable storage media of claim 16, wherein the acts further comprise providing a fresh version of the content to the application via an additional API after receiving the fresh version of the content from the content source.

19. The one or more computer-readable storage media of claim 18, wherein providing the content to the application via the additional API includes providing webpage content to a web browser application.

20. The one or more computer-readable storage media of claim 14, wherein a connection between the computing device and the content source is broken and, wherein the request for the content is stored in a queue until the connection between the computing device and the content source is restored.
